(19) United States
(12) Patent Application Publication
(10) Pub. No.: US 2004/0058029 A1
(43) Pub. Date: Mar. 25, 2004

(54) Golf ball core mold with improved ejector

(76) Inventor: Manuel G. Vargas, Fairhaven, MA (US)

Correspondence Address: Troy R. Lester, Acushnet Company, 333 Bridge Street, Fairhaven, MA, 02719, US

(21) Appl. No.: 10/247,211

(22) Filed: Sep. 19, 2002

(51) Int. Cl. B29C 45/40

(52) U.S. Cl. 425/444

(57) ABSTRACT

An improved mold ejector is provided. The mold ejector can be a poppet valve or an ejector pin. The surface of the bore of the ejector opposite the stem of the ejector is interrupted by at least one relief. The relief allows foreign particles that are trapped between the ejector stem and the bore to pass away from the ejector. The relief can also be defined on the surface of the stem. The relief also reduces the frictional forces between the ejector and the bore.

### FIELD OF THE INVENTION

This invention generally relates to an improved mold, and more specifically relates to golf ball core mold with an improved ejector.

### BACKGROUND OF THE INVENTION

Poppet valves and ejector pins are typically used to eject molded articles, such as golf ball cores, golf ball core assemblies or finished golf balls, from the mold after the articles have sufficiently hardened. Poppet valves or air poppet valves eject molded articles from the mold by communicating air pressure to the valve as the mold opens. The compressed air lifts a valve stem and its enlarged head away from the valve seat against the force of a spring, and separates the molded articles from the face of the mold. To close the valve, the compressed air is isolated from the valve and the force of the spring returns the valve stem to the valve seat. Ejector pins are similar to poppet valves, except that the pins are pushed into the mold by mechanical means, such as hydraulic or pneumatic power sources, to separate the molded articles from the mold face. Gravity or the same mechanical means returns the ejector pins to its withdrawn or closed position.

It is necessary for the head of the poppet valve and the ejector pin to withdraw to a position flush with the mold face so that it does not leave its imprint on the molded articles. Thus, the tolerances between the valve stem or pin and the bore are typically small. However, during production small particles of molded materials may become lodged in the spacing between the valve stem and valve bore preventing the stem head from withdrawing flush with the mold face. This leaves an undesirable imprint of the stem head on the molded articles. Production typically has to stop and the molds are clean to remove the lodged particles costing valuable production time.

Hence, there remains a need in the art for an improved mold ejector.

### SUMMARY OF THE INVENTION

The present invention is directed to a mold with an improved ejector.

The present invention is also directed to a mold with an ejector capable of purging trapped particles.

The present invention is also directed to a mold with an ejector having relief zones therein.

These and other objects of the present invention are realized by a mold ejector comprising a stem slidably disposed within a bore, wherein the stem comprises a head and the bore having a seat, such that in a withdrawn position the head is received within the seat and in an advanced position the head is spaced apart from the seat to push a molded article away from a mold face. The mold ejector further comprises at least one relief defined on either the bore or the stem allowing trapped particles to leave the ejector. Preferably, the at least one relief is defined along the longitudinal axis of the ejector.

The ejector can be either a poppet valve or an ejector pin.

The stem may also define at least one channel in communication with the at least one relief, such that compressed air is communicable to the ejector to move the ejector between the withdrawn position and the advanced position. Preferably, the at least one channel is positioned adjacent to the at least one relief, or alternatively the one channel is in communication with more than one relief. Additionally, the stem cooperates with a spring to assist the return to the withdrawn position.

The molded article can be a core of a golf ball, an intermediate layer or a cover of a golf ball.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a partial cross-sectional and partial cut-away view of a conventional mold ejector in the advanced position;

FIG. 2 is a cross-sectional view of the ejector shown in FIG. 1 along line 2-2;

FIG. 3 is a cross-sectional view of an ejector in accordance to the present invention in the advanced position along line 3-3 in FIG. 4;

FIG. 4 is a partial cross-sectional and partial cut-away view of the mold ejector shown in FIG. 3 along line 4-4;

FIG. 5 is a cross-sectional view of another embodiment of the ejector shown in FIG. 3; and

FIG. 6 is a cross-sectional view of another embodiment of the ejector shown in FIG. 3.

### DETAILED DESCRIPTION OF THE PREFERRED EMBODIMENTS

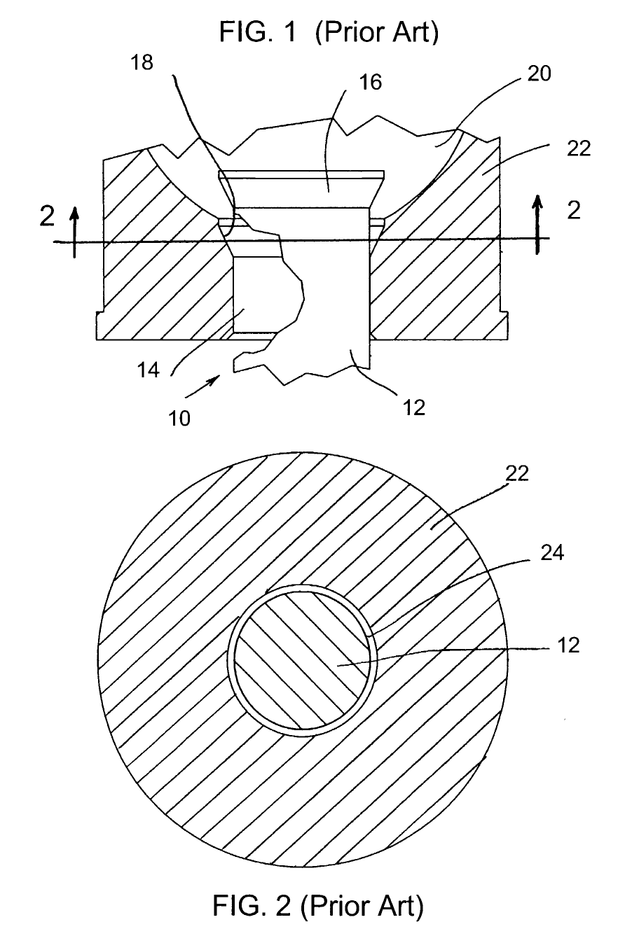

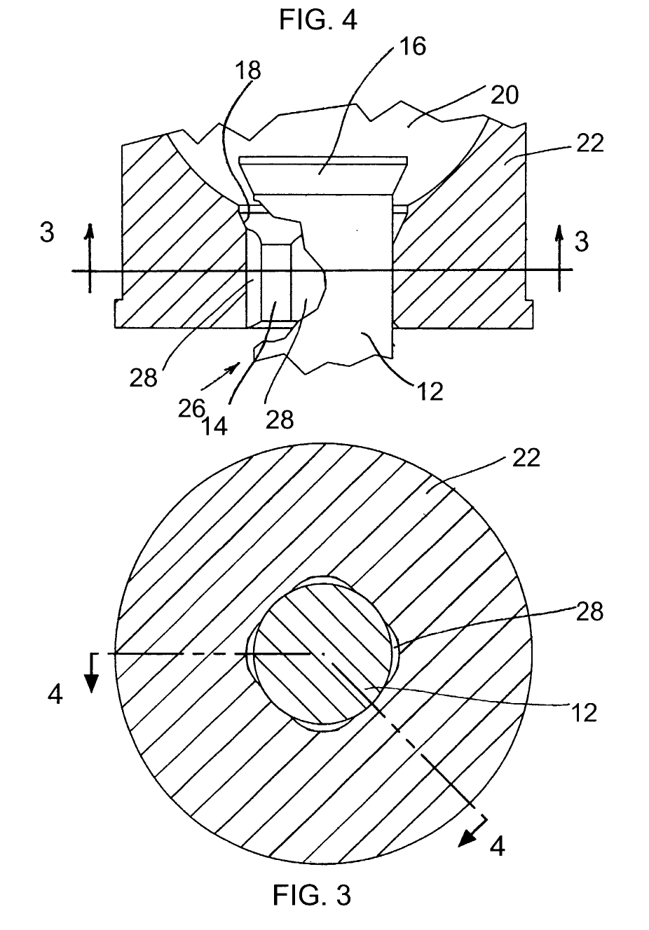

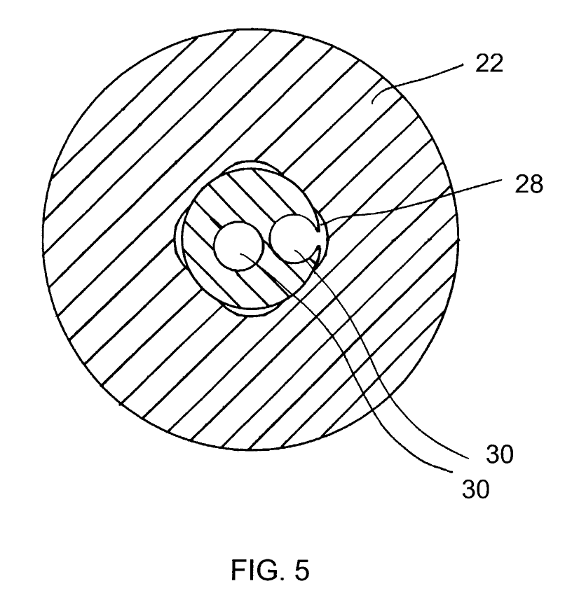

As illustrated in FIGS. 1 and 2, where like numbers designate like parts, reference number 10 generally designates an ejector, which can be an ejector pin or a poppet valve. Ejector 10 comprises stem 12 slidably disposed within bore 14. Stem 12 comprises enlarged head 16 configured and dimensioned to be received within seat 18, so that the top of head 16 become flush with mold face 20 of mold half 22. As shown, mold face 20 has a spherical surface to mold golf ball core or core assembly, including a core and an intermediate layer. Alternatively, mold face 20 also has multiple protrusions thereon to produce dimpled golf ball cover. Furthermore, while the top of head 16 is shown to be substantially planar in the drawings, this top may also be non-planar, e.g., having same curvature as the mold face. Ejector 10 is suitable for use with any type of molds to eject the molded articles, including but not limited to, injection molds and compression molds.

As illustrated in FIG. 1, ejector 10 is an ejector pin, also known in the art as a poppet pin, and stem 12 is pushed upward to the advanced position by any conventional mechanical or electrical means such as a pneumatic device, a hydraulic device, electrical motors and the like. The same conventional means may return stem 12 to the withdrawn position after the molded articles have been ejected. As used herein, the advanced position shown in FIGS. 1 and 3 indicates the position where head 16 of stem 12 is spaced from seat 18, and the withdrawn position indicates the position where head 16 rests within seat 18. Alternatively, a spring or gravity may return the stem 12 to the withdrawn position. When stem 12 is in the advanced position, shown in FIG. 1, foreign particles such as particles of molded material can enter the annular spacing 24 between seat 18 and head 16. Such foreign particles clog annular spacing 24 and prevent the return of stem 12 to its withdrawn position, thereby causing head 16 to protrude beyond mold face 20 and leave an undesirable imprint of head 16 on the molded articles.

The same problem is encountered with a poppet valve. The poppet valve serves a similar function as the ejector pin in a mold, among other functions. The most significant difference is that the valve stem of the poppet valve is in communication with a source of compressed air or other gasses. This source of compressed air pushes the valve stem into the advanced position against the urging force of a spring. The compressed air can finger between the contact surface between the molded articles and the mold face to separate them. When the compressed air is isolated from the poppet valve, the spring returns the valve to the withdrawn position. A conventional poppet valve is described in FIG. 1 and columns 1-2 in U.S. Pat. No. 6,443,421 B1. The '421 patent is incorporated herein by reference.

In accordance to one aspect of the present invention, as illustrated in FIG. 3 foreign particles can be discarded from ejector 26 by a series of reliefs 28 defined on bore 14 of the ejector. Reliefs 28 preferably extend along the longitudinal direction of bore 14 and are in communication with seat 18, which are adapted to receive head 16 as discussed above. When foreign particles are fallen into annular spacing 24, these particles pass through reliefs 28 and are dropped away from the mold. Hence, the stem 12 may fully return to its withdrawn position. While four reliefs 28 are illustrated in the drawings, any number of reliefs can be utilized.

In accordance to another aspect of the present invention, the frictional forces acting between stem 12 and bore 14 are reduced, because the contact surfaces between stem 12 and bore 14 are reduced by reliefs 28. Hence, stem 12 can return to its withdrawn position having to overcome less frictional forces. This is specifically more advantageous when gravity is the only available force returning the stem to the withdrawn position.

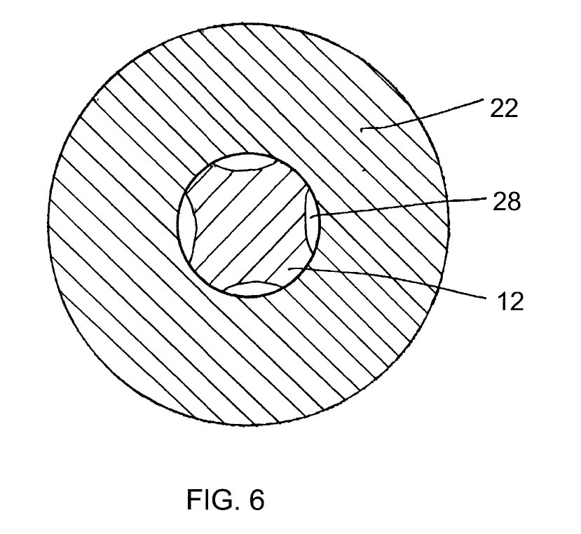

In accordance to another aspect of the invention, as shown in FIG. 5 stem 12 has at least one channel 30 defined therein. Channel 30 is preferably in fluid communication with at least one relief 28, such that compressed air can flow through channel 30 and relief 28 to push head 16 away from seat 18 to separate the molded articles from the mold face. Channel 30 may be positioned immediately adjacent to relief 28 or may be positioned internal to stem 12 and have a spiral pathway to communicate with one or more relief 28. Furthermore, a spring may be attached to stem 12 to assist the return of the stem to the withdrawn position.

In accordance to another aspect of the invention, reliefs 28 may be defined on stem 12 as illustrated in FIG. 6. In this embodiment, preferably reliefs 28 terminate below the top of head 16.

Ejector 26 of the present invention is particularly suitable for molding single and multi-layered golf ball cores, such as those described and claimed in U.S. Pat. Nos. 6,093,357, 6,096,255, 6,172,161B1, 6,180,040B1, 6,180,722B1, 6,207,095B1 and 6,303,065B1.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

What is claimed is:

1. A mold ejector comprising:
a stem slidably disposed within a bore, wherein the stem comprises a head and the bore comprises a seat, such that in a withdrawn position the head is received within the seat and in an advanced position the head is spaced apart from the seat to push a molded article away from a mold face, and
at least one relief defined on either the bore or the stem allowing trapped particles to leave the ejector.

2. The mold ejector of claim 1, wherein the ejector is a poppet valve.

3. The mold ejector of claim 1, wherein the ejector is an ejector pin.

4. The mold ejector of claim 1, wherein the at least one relief is defined along the longitudinal axis of the ejector.

5. The mold ejector of claim 1, wherein the stem defines at least one channel in communication with the at least one relief, such that compressed air is communicable to the ejector to move the ejector between the withdrawn position and the advanced position.

6. The mold ejector of claim 5, wherein the at least one channel is positioned adjacent to the at least one relief.

7. The mold ejector of claim 5, wherein the at least one channel is in communication with more than one relief.

8. The mold ejector of claim 1 comprising four reliefs.

9. The mold ejector of claim 1, wherein the stem cooperates with a pneumatic device to move the stem between the withdrawn position and the advanced position.

10. The mold ejector of claim 1, wherein the stem cooperates with a hydraulic device to move the stem between the withdrawn position and the advanced position.

11. The mold ejector of claim 1, wherein the stem cooperates with a motor to move the stem between the withdrawn position and the advanced position.

12. The mold ejector of claim 1, wherein the stem cooperates with a spring to assist the return to the withdrawn position.

13. The mold ejector of claim 1, wherein the molded article is a core of a golf ball.

14. The mold ejector of claim 1, wherein the molded article is an intermediate layer of a golf ball.

15. The mold ejector of claim 1, wherein the molded article is a cover of a golf ball.

16. The mold ejector of claim 1, wherein the at least one relief is defined on the bore.

17. The mold ejector of claim 1, wherein the at least one relief is defined on the stem.
